(19) United States
(12) Patent Application Publication
(10) Pub. No.: US 2015/0186824 A1
(43) Pub. Date: Jul. 2, 2015

(54) FACILITATING DAY-WISE PLANNING OF EFFORT REQUIRED FROM A RESOURCE FOR AN INDIVIDUAL TASK

(71) Applicant: Oracle International Corporation, Redwood Shores, CA (US)

(72) Inventor: Niladri Sekhar De, Hyderabad (IN)

(73) Assignee: Oracle International Corporation, Redwood Shores, CA (US)

(21) Appl. No.: 14/144,618

(22) Filed: Dec. 31, 2013

(51) Int. Cl. G06Q 10/06

(52) U.S. Cl. CPC G06Q 10/06315

(57) ABSTRACT

According to an aspect of the present disclosure, effort parameters for a task to be performed by a resource are maintained, the effort parameters together specifying a sequence of initial component efforts (as a number of base intervals) for the resource in each of a progression of super intervals in relation to performance of the task by the resource. A graph containing graphical elements representing the sequence of component efforts over the progression of super intervals is then sent for display. In response to receiving an input indicating a change of an effort parameter, a sequence of changed component efforts for the progression of super intervals is computed and the graph updated with the sequence of changed component efforts. Thus, a user may make desired changes to the component efforts and view the effect of such changes on all of the component efforts in an interactive manner.

### BACKGROUND OF THE DISCLOSURE

1. Technical Field

The present disclosure relates to task management systems and more specifically to facilitating day-wise planning of effort required from a resource for an individual task.

2. Related Art

A task generally refers to an activity to be performed. There are often situations when organizations are required to perform multiple related tasks, for example, as part of a project. The tasks may be related for the overall objective, or due to the tasks being required to be performed in sequence, parallel, etc.

Performance of tasks requires effort from resources. A resource, as described in the examples below, refers to a person assigned to perform a task. However, resources can also be in the form of objects such as meeting rooms, machines, etc., which are sharable across different tasks and thus required to be scheduled for specific tasks. Similarly, if multiple persons/objects are modeled as a single entity for scheduling purpose, such single entity may also be viewed as a resource.

Effort refers to the duration of use of a resource. Effort is expressed as a number of units of time (hereafter “base intervals”). The aggregate effort required for completion of the task, is referred to as the total effort, and may be measured in terms of the number of base intervals. As used herein, the total effort refers to that required from only a single resource for that individual task.

Planning the performance of a task often entails distributing the total effort over progression of longer units of time, which are hereafter referred to as “super intervals”. A super interval can be best understood with respect to an analogy in which hours represents a base interval, while a day may represent a super interval. Thus, a super interval would typically contain a specific number of base intervals (e.g., number of hours in a day or days in a month).

The effort in each super interval is termed as component effort in that super interval. Assuming an effort is scheduled to be performed for 6 hours each day over 5 days, the component effort in each of the 5 days is said to be 6 hours each. The sum of the component efforts thus represents the total effort.

For ease of understanding, the description herein is provided substantially with base interval being hours and super interval being a day. However, alternative combinations of base and super intervals can be employed, as will be apparent to a skilled practitioner based on the disclosure provided herein.

Aspects of the present disclosure facilitate day-wise planning of effort required from a resource for an individual task (or in general, planning of effort in super intervals).

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which day-wise planning of effort required for individual tasks is facilitated according to an aspect of the present disclosure.

FIG. 3 depicts the manner in which tasks are displayed along a timeline in one embodiment.

FIG. 4A depicts the manner in which effort related information for an individual task is provided to a user/task manager in one embodiment.

Each of FIGS. 4B and 4C depicts the manner in which a corresponding planning profile is applied to the distribution of planned efforts of an individual task in one embodiment.

FIGS. 4D and 4E together depicts the manner in which a planning profile is created based on a task and later applied to the distribution of planned efforts for another task in one embodiment.

FIG. 4F depicts the manner in which a user/task manager is enabled to report actual progress on the task and correspondingly change remaining component efforts in one embodiment.

FIG. 5 depicts the manner in which a user/task manager is enabled to change the total effort for an individual task in one embodiment.

FIG. 6 illustrates the manner in which effort parameters for an individual task to be performed by a resource is maintained in one embodiment.

FIG. 7 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

According to an aspect of the present disclosure, effort parameters for a task to be performed by a resource are maintained. The effort parameters together specify a sequence of initial component efforts (as a number of base intervals/hours) for the resource in each of a progression of super intervals (days) in relation to performance of the task by the resource. A graph containing graphical elements representing the sequence of component efforts over the progression of super intervals is then sent for display. In response to receiving an input indicating a change of an effort parameter for the task, a sequence of changed component efforts for the progression of super intervals is computed and the graph updated with the sequence of changed component efforts.

Thus, a user/task manager may make desired changes to the component efforts and view the effect of such changes on all of the component efforts in an interactive manner. The day-wise planning of effort required from a resource for an individual task is accordingly simplified.

According to another aspect of the present disclosure, a user/task manager is facilitated to manually change the component effort for a specific super interval by manipulating the dimension of a graphical element corresponding to the component effort. In response to the manipulation indicating a new component effort for the specific super interval, the sequence of changed component efforts is computed while keeping the changed component effort for the specific super interval equal to the new component effort.

In one embodiment, the effort parameters together also specify a total effort planned for performance of the task by the resource, with the total effort being equal to the sum of the sequence of initial component efforts. The sequence of changed component efforts is computed such that the sum of the sequence of changed component efforts also equals the total effort.

According to one more aspect of the present disclosure, the input (received from a user) indicates a planning profile to be applied to the task, with the planning profile specifying a relative distribution pattern of the component efforts over the progression of super intervals. In response to the input indicating the planning profile, the sequence of changed component efforts are computed consistent with the distribution pattern specified in the planning profile.

In one embodiment, the distribution pattern is specified relative to the average effort per super interval (computed as the total effort divided by the number of super intervals in the progression). For example, the distribution pattern may indicate that the component effort for a first set of super intervals is to be greater than the average effort and the component effort for a second set of super intervals is to be less than the average effort. The sequence of changed component efforts may be computed consistent with such a distributed pattern.

According to an aspect of the present distribution, a user/task manager is facilitated to create a new planning profile based on a second sequence of changed component efforts specified for another/second task (with the second sequence of component efforts defining the relative distribution pattern). In response to the user/task manager then indicating that the new planning profile is to be applied to the individual task (noted above), the sequence of changed component efforts for the individual task is computed to have the same relative distribution pattern as the second sequence of component efforts (for the second task).

According to yet another aspect of the present disclosure, the effort parameters also specify a sequence of remaining component efforts (as a number of base intervals/hours) in each of the progression of super intervals in relation to performance of the task by the resource. The remaining component efforts are also sent for display along with the corresponding associated initial component efforts (which represents planned component efforts) over respective the progression of super intervals.

According to an aspect of the present disclosure, a user/task manager is facilitated to change the remaining component effort for a specific super interval by manipulating the dimension of a graphical element corresponding to the remaining component effort. In response to such a change, the remaining component effort is marked as an actual effort put in by the resource in the performance of the task during the specific super interval. The sequence of changed component efforts is determined to correspond to a set of remaining component efforts which have associated super intervals subsequent to the specific super interval in the progression of super intervals. The set of remaining component efforts is then computed such that the sum of the set of remaining component efforts is equal to the total effort less the actual effort.

In one embodiment, remaining component efforts having the number of base intervals greater than a standard number of base intervals expected to be put in by the resource in each super interval (e.g., eight hours of normal work day) are identified. For each identified remaining component effort, the number of base intervals above the standard number is indicated as over-allocated base intervals for the resource in the corresponding super interval.

According to one more aspect of the present disclosure, the graph (sent for display) further includes graphical elements representing the total effort planned for performance of the task by the resource. In response to manipulation of the graphical elements to indicate a new total effort, the sequence of changed component efforts are computed such that the sum of the sequence of changed component efforts equals said new total effort.

In one embodiment, the manipulation is one of extending or reducing the progression of super intervals. The extending indicates that the new total effort is equal to the (previous) total effort plus the average effort multiplied by the number of super intervals sought to be added by the extension. The reducing indicates that the new total effort is equal to the (previous) total effort minus the sum of the initial component efforts in super intervals sought to be removed.

The manipulation may also be for increasing or decreasing the number of base intervals for all super intervals to a changed number of base intervals. As a result, the new total effort is indicated to be equal to the number of super intervals in the progression of super intervals multiplied by the changed number of base intervals.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

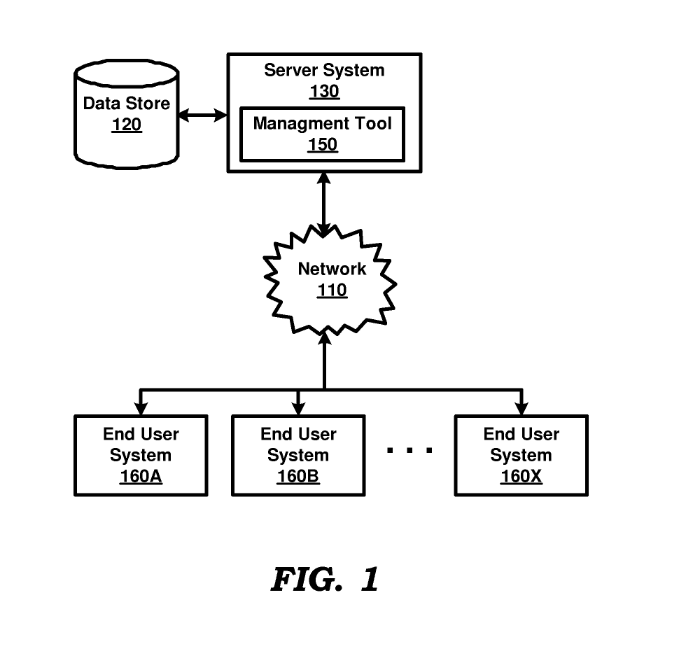

FIG. 1 is a block diagram illustrating an example environment in which several aspects of the present disclosure can be implemented. The block diagram is shown containing network 110, data store 120, server system 130 (shown executing management tool 150) and end user systems 160A-160X.

Merely for illustration, only representative number/type of systems is shown in the Figure. Many environments often contain many more systems, both in number and type, depending on the purpose for which the environment is designed. Each system/device of FIG. 1 is described below in further detail.

Network 110 provides connectivity between server system 130 and end user systems 160A-160X, and may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of data (such as the details of the tasks, the resource assigned to each task, the total effort planned for each task, the day-wise component effort planned for each task, etc.) by applications executing in server system 130. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts.

Each of end user systems 160A-160X represents a system such as a personal computer, workstation, mobile station, mobile phones, computing tablets, etc., used by users to generate (user) requests directed to applications executing in server system 130. The user requests may be generated using appropriate user interfaces (for example, web pages provided by applications executing in server system 130). In general, an end user system sends user requests to an application (executing in server system 130) for performing desired tasks/services and receives corresponding responses containing the results of performance of the requested tasks/services.

Server system 130 represents a server, such as a web/application server, executing applications/software based tools (e.g., management tool 150) capable of processing (user) requests received from users using one of end user systems 160A-160X. Server system 130 may use data stored internally (for example, in a non-volatile storage/hard disk within the system), external data (for example, stored in data stores such as 120) and/or data received from external sources (e.g., from the user) in processing of the user requests. The server system then sends the result of processing of the user requests to the requesting end user system (one of 160A-160X).

Management tool 150 represents a project/task management application (executing in server system 130) that enables users to manage tasks based on user requests received from various end user systems 160A-160X. One of the common management actions is the planning of effort required for individual tasks based on various factors such as the cumulative effort required for all the tasks, the number of resources available for allocation to the tasks, the effort that can be put in by each resource, etc.

Aspects of the present disclosure facilitate day-wise planning of effort required for individual tasks.

### 3. Facilitating Day-Wise Planning of Effort

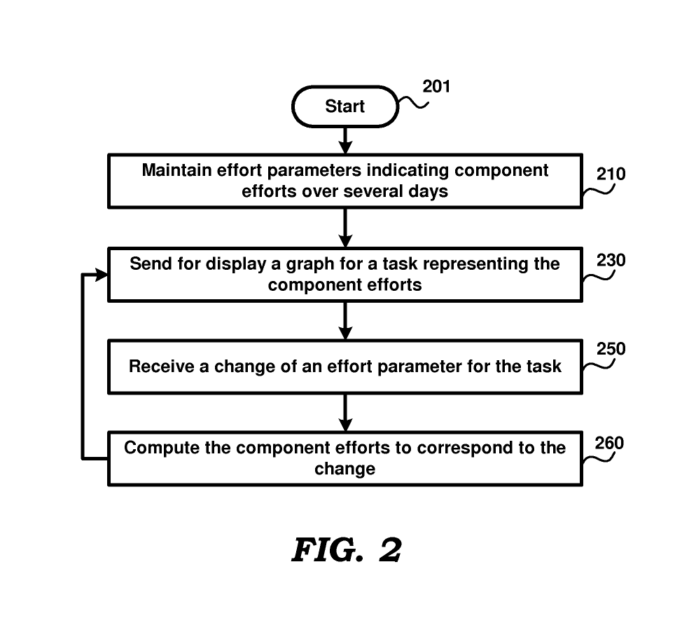

FIG. 2 is a flow chart illustrating the manner in which day-wise planning of effort required for individual tasks is facilitated according to an aspect of the present disclosure. The flowchart is described with respect to the systems of FIG. 1, in particular, management tool 150, merely for illustration. However, the features can be implemented in other systems and environments also without departing from the scope and spirit of various aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, management tool 150 maintains effort parameters indicating day-wise planned effort (that is, the component effort per day) by a resource for an individual task. In other words, the effort parameters are necessary to be specific enough to be able to identify the hours (base intervals) required to be allocated in each specific day (super interval) for performance of the task. For example, the effort parameters may indicate the total effort (in number of hours), a duration for the tasks (in number of days or as start and finish dates) and a planning profile indicating the relative distribution pattern of the effort over the days (e.g., average). In the alternative, the effort parameters may simply indicate the specific number of hours in each of the days.

In step 230, management tool 150 sends for display a graph representing the day-wise planned/component effort based on the effort parameters. Any necessary computations may be performed to determine the day-wise planned effort and elements constituting the graph depicting the respective effort against each day, may be formed and sent for display. Each component effort may be represented suitably by a corresponding graphical element.

In step 250, management tool 150 receives a change of an effort parameter. Such a change may be express as to the change of value of one of the maintained parameters, or such change (to a maintained parameter) may necessarily be implied by the received data. The change may be received from a task manager managing assignment of various tasks to resources/users.

In step 260, management tool 150 computes the day-wise planned/component effort corresponding to the change. The computation generally depends on the nature of the change received in step 250. Several examples of such a change and corresponding computations are described below in detail. Control thereafter passes to step 230, in which the graph is updated to reflect the changed/computed day-wise allocation of hours.

Thus, steps 230-260 may be performed iteratively for each change input by the task manager, to thereby facilitate interactive day-wise planning of effort required from a resource for an individual task. The manner in which management tool 150 may provide such day-wise planning of effort according to at least some of the steps of FIG. 2 is illustrated below with examples.

### 4. Illustrative Examples

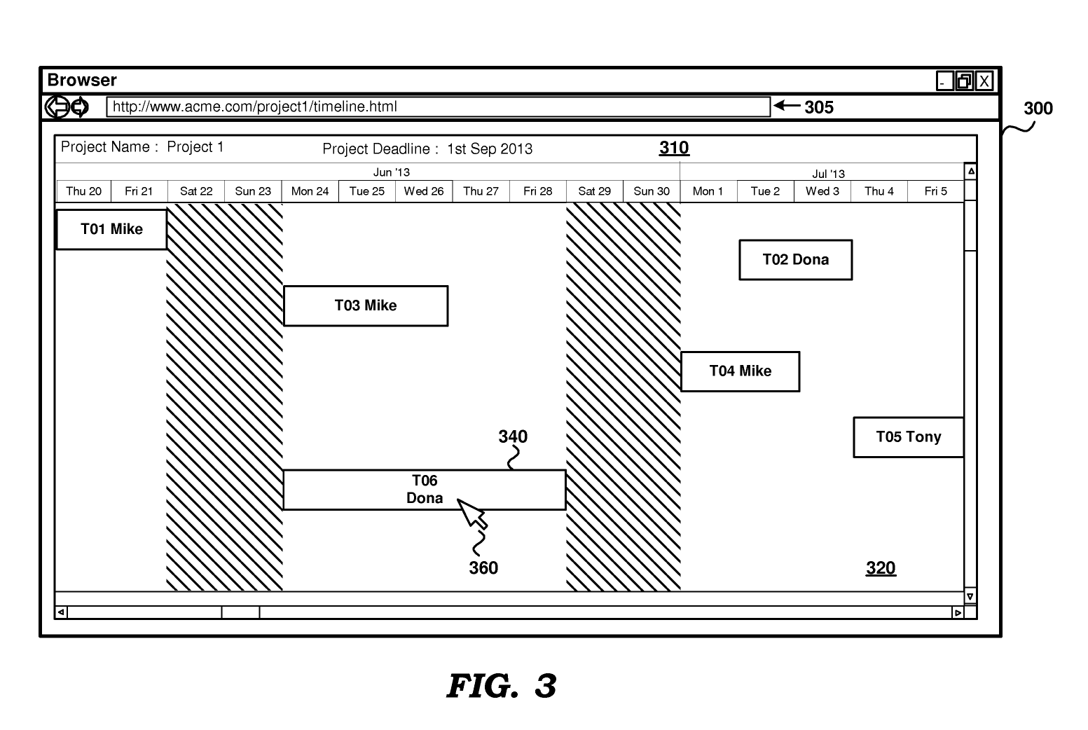

FIGS. 3, 4A-4D, 5 and 6 together illustrates the manner in which users are facilitated to perform day-wise planning of effort required for individual tasks in one embodiment. Each of the Figures is described in detail below.

Several features of the present disclosure are described below with respect to the tasks of a project displayed along a timeline, for illustration. As is well known in the relevant arts, a timeline provides a common reference to indicate relevant time instances (dates and times) such as start and finish time instances, corresponding to various tasks. The tasks are represented along the timeline based on various factors such as the number of days required for performing each task, the availablility of resources for performance of the tasks, the relationships among the tasks, etc. However, in alternative embodiments, the tasks may not form part of a project (or a timeline) and may be any freeform unstructured task/activity whose effort is to be planned.

FIG. 3 depicts the manner in which tasks are displayed along a timeline in one embodiment. Display area 300 depicts a portion of a user interface provided on a display unit (not shown in FIG. 1) associated with one of end user systems 160A-160X (assumed to be 160A for illustration). In one embodiment, display area 300 corresponds to a webpage accessed by the users using a browser in response to sending a request (including an identifier of the webpage, as indicated by the text in display area 305) from end user system 160A to management tool 150. The web page is received from management tool 150 prior to being displayed (using the browser) on the display unit.

Display area 310 indicates that the details of a project named “Project 1” having a project deadline of “1 Sep. 2013” is being displayed in the user interface. Display area 320 provides a timeline of the various tasks in the project. The timeline indicating the various days of interest is shown displayed along the horizontal direction. The timeline is shown indicating the months (such as “June '13” and “July '13”) and the corresponding days (Monday, Tuesday, etc.) of interest in each of the months. It may be observed that common non-working days such as Saturdays and Sundays are shown as cross-hatched regions to indicate all the resources are not available during such days.

Display area 320 also displays the various tasks of the project below the timeline. Each task is shown in the form of a rectangle with the name of the task (such as “T01”, “T02” etc.) and the name of the resource (such as “Mike”, “Dona”, etc.) assigned to the task shown in the middle of the rectangle. Each rectangle is shown between the corresponding start dates and finish dates of the task. The values of the start and finish dates of a task indicates the planned date/time at which the task is to be respectively started and completed. The width (along the horizontal direction) of the rectangle indicates the duration of the corresponding task (in number of days).

Thus, the interface of FIG. 3 depicts various tasks of a project along a timeline. It may be observed that only the duration/the number of days (super intervals) planned for each task is shown along the timeline. However, a user/task manager may wish to view the details of planning of the effort for an individual task (e.g. task 340) shown along the timeline.

An aspect of the present disclosure facilitates the user/task manager to select an individual task from the tasks shown along the timeline and to view the total effort (in terms of hours/base intervals) and also the day-wise component efforts planned for the selected task. The manner in which management tool 150 provides the information related to effort for a selected task (such as task 340) is described below with examples.

### 5. Providing Effort Related Information for an Individual Task

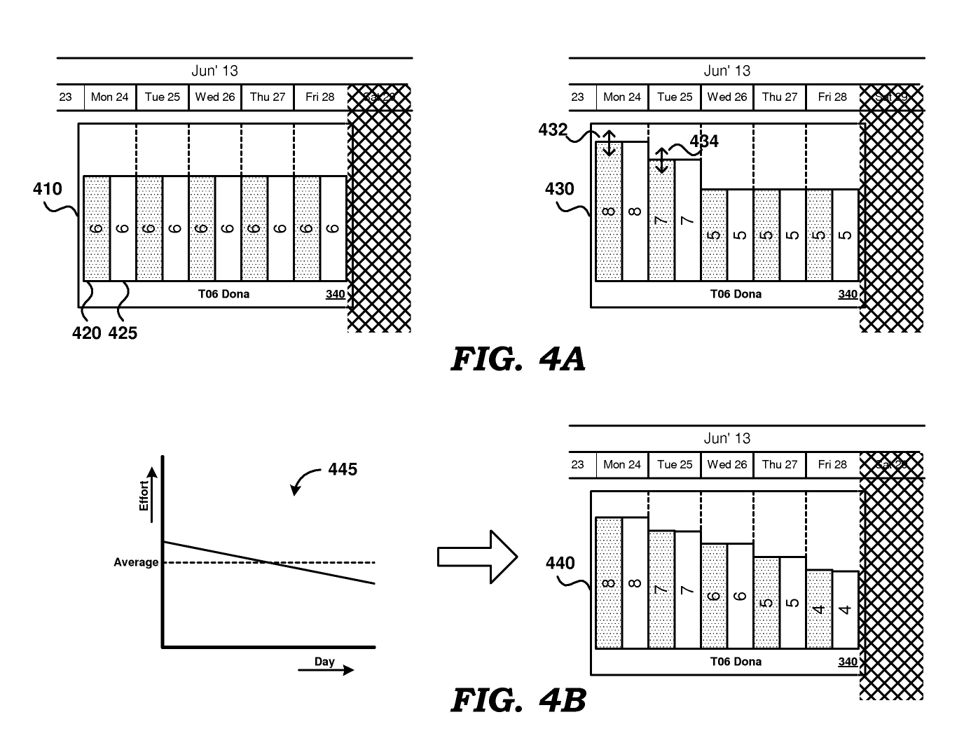

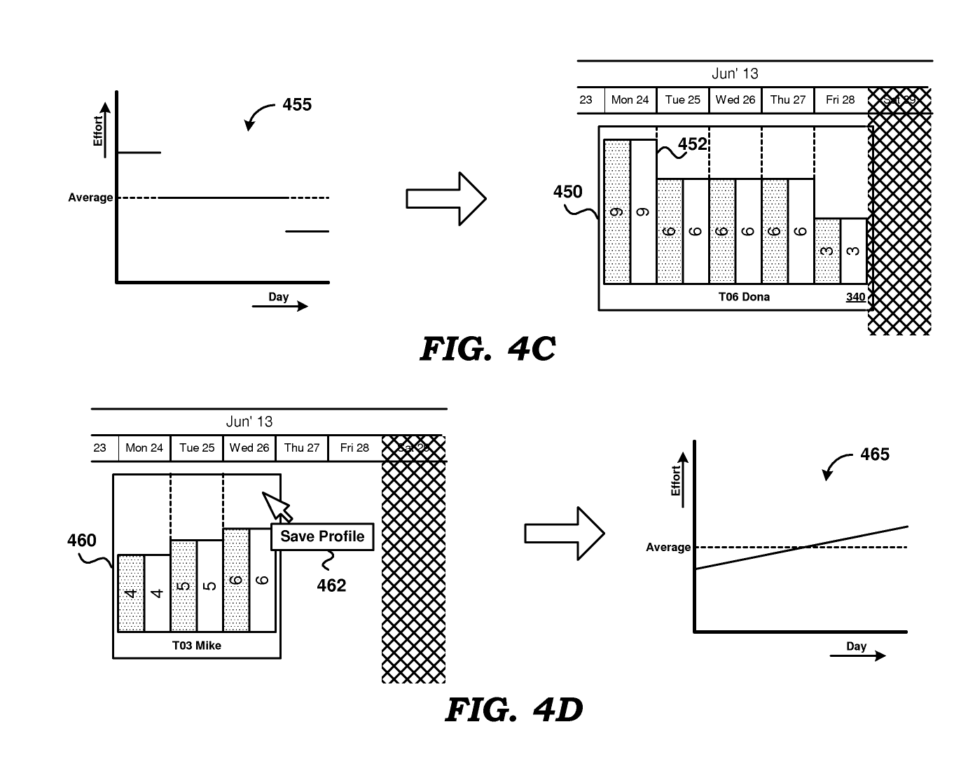

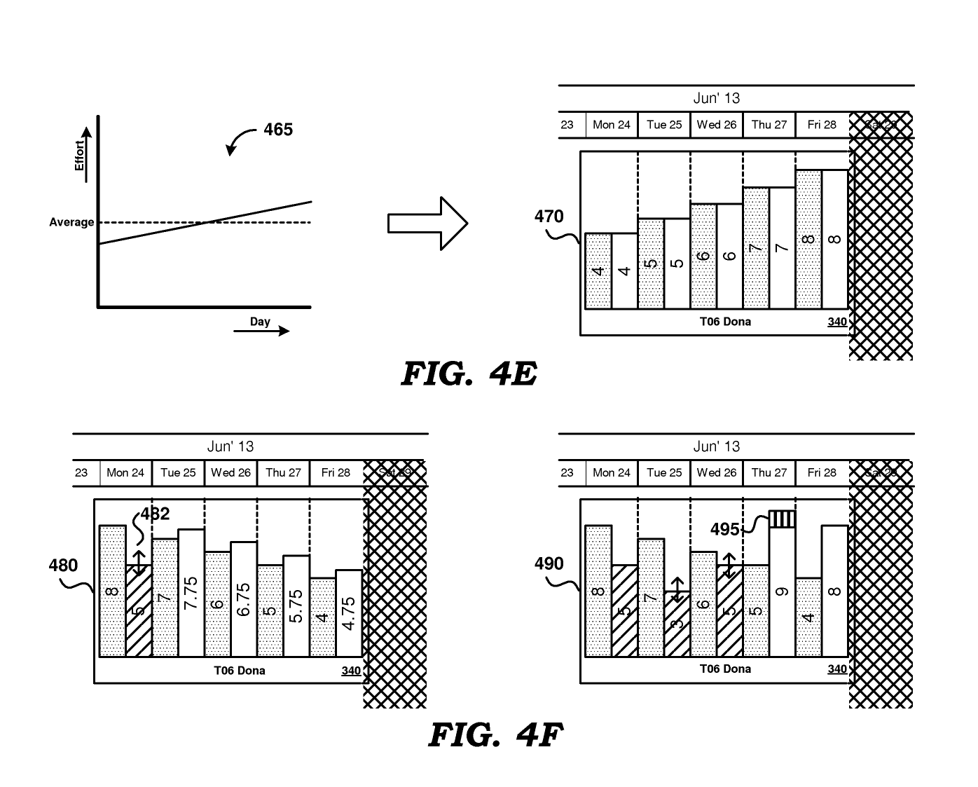

FIGS. 4A-4D illustrates the manner in which effort related information for an individual task is provided in one embodiment. Each of display area 410, 430, 440, 450, 460 and 470 depicts a corresponding portion of a user interface that is provided on a display unit associated with end user system 160A (similar to display area 300). Each of the Figures is described in detail below.

For illustration, it is assumed that the user has selected task 340 (T06 Dona) in timeline 320 of FIG. 3 and accordingly various features of the present disclosure are described with respect to selected task 340. Furthermore, the display areas of FIGS. 4A-4D depict a close-up view of the selected task (displayed in response to the selection), and includes only the relevant portions of the timeline shown in FIG. 3. It may be appreciated that the detailed view of FIGS. 4A-4D may be similarly provided for other tasks shown along the timeline (320) or displayed embedded as part of the corresponding task in timeline 320, as will be apparent to one skilled in the relevant arts by reading the disclosure herein.

FIG. 4A depicts the manner in which effort related information for an individual task is provided to a user/task manager in one embodiment. Display area 410 is shown displaying the effort information for selected task 340 (as indicated by the text at the bottom of display area 410). In particular, the effort information is displayed in the form of a graph with the days along the horizontal axis and the day-wise/component effort (in number of hours) along the vertical axis. In other words, the graph indicates the planned number of hours/base intervals against each day/super interval of a progression of days/super intervals.

It may be observed that the graph is shown in the form of a bar graph, with each component effort (per day) represented as a corresponding bar in the graph. In general, the graph contains graphical elements corresponding to the component efforts, with the dimension (e.g., width, height, depth, etc.) of the graphical element representing the magnitude (number of hours/base intervals) of the component effort. Thus, in alternative embodiments, the effort information may be displayed using other types of graphs (such as line graph) or other visual representations (for example, using colors) as will be apparent to one skilled in the relevant arts by reading the disclosure herein.

According to an aspect of the present disclosure, the bar graph is shown indicating both the planned effort and the remaining effort (as individual bars) for each day in the performance of the selected task 340. The planned effort bars (such as 420) are shown as dotted regions, in contrast to the remaining effort bars (such as 425) that are shown as plain regions. Each bar is also shown indicating (vertically) numerical values (such as 6) representing the number of hours (component effort) represented by the bar in the graph. Thus, it may be observed that planned effort and remaining effort is shown for each day.

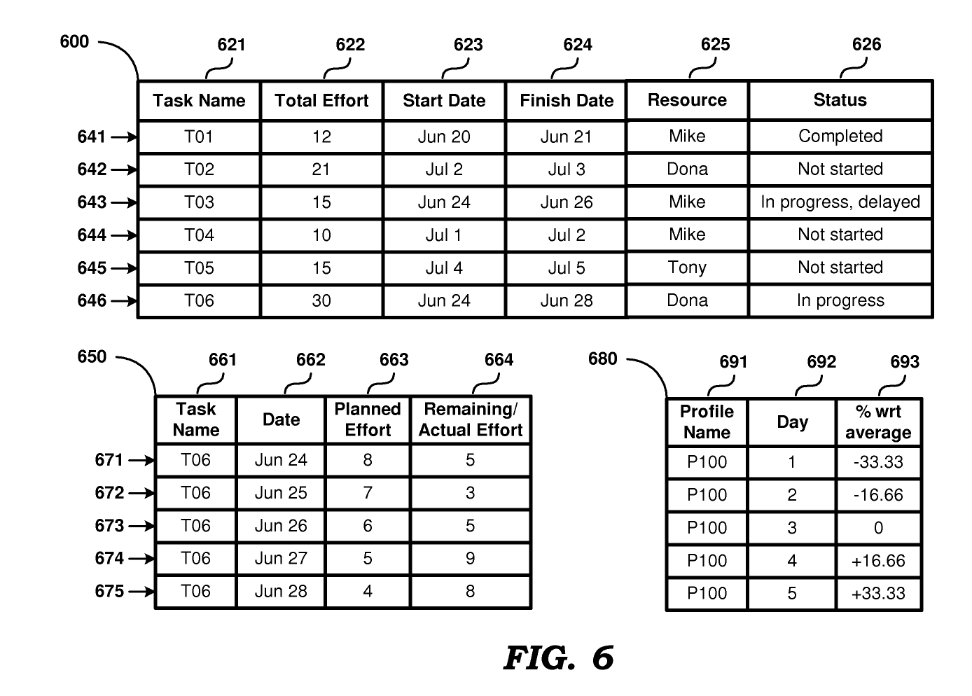

It may be appreciated that the same height shown for all the bars in display area 410 indicates that the total effort has been distributed uniformly over all the days in the duration of the task. The numerical value 6 thus represents the average effort/number of hours computed by dividing the total effort (30 hours) with the duration (5 days) of the task. The specific numerical values to be displayed may be computed based on the values of the effort parameters (total effort, duration, etc.) maintained by management tool 150, as described in detail below with respect to FIG. 6.

Thus, a task manager is provided both the planned and remaining effort related information for an individual task (340). It may be appreciated that a task manager may wish to change the planned component effort for some of the days in the duration of the task. The manner in which management tool 150 facilitates a user to change the planned component efforts is described below with examples.

### 6. Changing Planned Component Efforts

Referring again to FIG. 4A, display area 430 depicts the manner in which a user/task manager is enabled to change the component efforts manually. In one embodiment, the user uses a pointing device such as a mouse (or a finger in a touch enabled interface) to select the bar corresponding to the desired component effort and to drag the bar (to increase or decrease the height of the bar) to specify a new value for at least one of the component efforts. In other words, the user manipulates the dimension of the graphical element to specify the changed/new value for the corresponding component effort. Alternatively, the user may use a single or a combination of input devices (such as a keyboard, mouse, etc.) to specify the values of the desired component efforts.

Management tool 150, in response to a drag action, computes changed values (number of hours) for the component effort per day and then updates the displayed graph to reflect the newly computed values. The new values are computed while ensuring that the total effort required for performance of the task is maintained the same (as earlier). Accordingly, when a drag action causes a component effort of a specific day to be increased over the average effort, management tool 150 may decrease the component efforts for one or more of the rest of the days (excluding the specific day) to maintain same total effort. When the component effort is decreased, one or more other component efforts may be increased accordingly.

It should be noted that planned efforts only for the future dates (those after the current date on which the drag actions are performed) need to be re-computed and displayed to the user. The computed efforts of the past dates (before the current date) are assumed to have been performed or overridden by the specification of the actual effort (as described below with respect to FIG. 4D).

In display area 430, the user is shown performing two drag actions (as indicated by the two headed arrow) 432 and 434 with respect to the component efforts for the days June 24 and June 25 respectively. Drag action 432 is shown increasing the component effort for June 24 to 8 hours, while drag action 434 is shown increasing the component effort for June 25 to 7 hours. As noted above, management tool 150 decreases some of the other component efforts to maintain the same total effort (30 hours). In one embodiment, all the other component efforts (on June 26, June 27 and June 28) are uniformly decreased, assuming that the current date is before the start date (June 24) of the task. Thus, each of the other three component efforts (other than the two changed) are shown as 5 hours (computed as (30−(8+7))/3).

Thus, a user is enabled to change the component efforts manually of an individual task (340). It may be appreciated that such manual changing of component efforts for a large number of tasks (such as those on timeline 320) may cause substantial overheads to the user/task manager. An aspect of the present disclosure facilitates the user to modify the efforts of multiple tasks by applying desired planning profiles as described below with examples.

### 7. Applying and Creating Planning Profiles

As noted above, a planning profile indicates the relative distribution pattern of the component efforts over a progression of days. The planning profile is typically in the form of a line graph with days along the horizontal axis and effort along the vertical axis. The line in the graph indicates the manner in which effort is to be distributed per day, typically in relation to the average effort per day.

Each of FIGS. 4B and 4C depicts the manner in which a corresponding planning profile is applied to the distribution of planned efforts of an individual task in one embodiment. Referring to FIG. 4B, display area 445 depicts a planning profile that indicates that the effort is to be distributed such that there is a above average effort in the first few days (as indicated by the solid line being above the dotted average effort line) which gradually tapers down (as indicated by the negative slope of the solid line) to a below average effort in the last few days (as indicated by the solid line being below the dotted line) of the duration.

The user may indicate (using one or more input devices) that planning profile 445 is to be applied to the efforts of task 340 shown in display area 410. In response to the indication, management tool 150 computes the component efforts based on the indicated planning profile (445) and displays the computed efforts. Thus, display area 440 shows component efforts that begin with 8 hours (above average) for the first days, tapers gradually (7, 6, 5 . . . ) and ends with 4 hours (below average) for the last day consistent with planning profile 445.

Referring to FIG. 4C, display area 455 depicts a planning profile that indicates that the effort is to be distributed such that there is a high effort in the first few days and a low effort in the last few days (as indicated by the solid line being substantially above/below the dotted line), with the intermediate days having average effort (a solid line along the dotted line). In response to a user indicating that planning profile 455 is to be applied to the efforts of task 340 shown in display area 410, management tool 150 computes the component efforts and provides the display of display area 450. It may be observed that in display area 450, the computed efforts are 9 hours (substantially high) for the first day, 6 hours (average) for the intermediate days and 3 hours (substantially low) for the last day consistent with planning profile 455.

Thus, the user is enabled to specify desired component efforts by applying appropriate planning profiles to the individual tasks. An aspect of the present disclosure enables the user/task manager to create a new planning profile based on a second sequence of changed component efforts specified for another/second task (with the second sequence of component efforts defining the relative distribution pattern). In response to the user/task manager then indicating that the new planning profile is to be applied to the individual task (noted above), the sequence of changed component efforts for the individual task is computed to have the same relative distribution pattern as the second sequence of component efforts (for the second task).

Referring to FIG. 4D, display area 460 depicts the manner in which a user/task manager is facilitated to create a new planning profile. Display area 460 indicates that the user has changed the planned component efforts for the task T03 (allocated to the resource Mike) to a desired sequence (4, 5, and 6). The user may then click/select a menu/button to indicate that a new planning profile is to be created based on the sequence shown in display area 460. For example, the user may perform a right click of the mouse, and the select the “Save Profile” option 462 shown in the right click menu (displayed in response to the right click).

In response to the user selecting option 462, management tool 150 creates a new planning profile corresponding to the sequence of component efforts specified for the task (T03). It may be observed that the component efforts are shown to be starting below the average effort (of 5 hours for task T03) in the first day, gradually rising up (from value 4 to 6) and ending above the average effort. Accordingly, management tool 150 may store a line graph with a solid line having a positive slope (that starts below the average effort and ends above the average effort) as shown in display area 465. The user/manager is accordingly facilitated to create a new planning profile.

Referring to FIG. 4E, display area 465 depicts the planning profile previously created by the user using the component efforts specified for task T03 (allocated to the resource Mike). The user may indicate (using one or more input devices) that planning profile 465 is to be applied to the efforts of task 340 shown in display area 410. In response to the indication, management tool 150 computes and displays (as shown in display area 460) the component efforts that begin with 4 hours (below average) for the first few days, rises gradually (5, 6, 7 . . . ) and ends with 8 hours (above average) for the last few days consistent with planning profile 465.

Thus, a user is facilitated to create desired planning profiles and to apply the created planning profiles to multiple tasks shown along a timeline (320). Accordingly, the overheads to the user/task manager in changing the component efforts may be substantially reduced.

As noted above, a task manager is provided both the planned and remaining effort related information for an individual task (340). The manner in which management tool 150 facilitates a user to change the remaining component efforts is described below with examples.

### 8. Changing Remaining Component Efforts

In one embodiment, a user/task manager changes the remaining component efforts by specifying the actual effort spent (per day) in the performance of the individual task. The user may be allowed to specify the actual efforts for only the past dates (before the current date). In response to specifying the actual efforts for a set of days, management tool 150 computes the remaining component efforts for the other days (excluding the set of days) and then updates the graph shown to the user.

The actual effort spent may be specified in any convenient manner. In one embodiment, the user/task manager may manipulate the graphical elements (such as the bars, borders, etc.) shown in the graphs of FIGS. 4A-4C for specifying the actual efforts. For illustration, the description is continued assuming that the user is manipulating the graphical elements in the graph of display area 440.

FIG. 4D depicts the manner in which a user/task manager is enabled to change remaining component efforts in one embodiment. In display area 460, the user is shown performing a drag action 462 on a remaining effort bar for June 24. In response to drag action 462, the remaining effort bar (shown as a plain region) is marked and displayed as an actual effort bar (shown as a slashed region), with the corresponding numerical value ‘5’ indicating the actual effort spent by the allocated resource (Dona) in the performance of task 340 on June 24. The display of the bars in the graphs using different shaded regions (slashed in contrast to plain) facilitates the user/task manager to easily distinguish the actual effort bars from the remaining effort bars.

Management tool 150 then computes the remaining component efforts for the other days (subsequent to the super interval/day for which the actual effort is specified) and updates the graph with the newly computed efforts. For example, the total difference between the planned and actual efforts (in this example, 8−5=3 hours) for the specified set of days may be distributed among the component efforts for the other days. According to an aspect of the present disclosure, the remaining component efforts are also computed based on a planning profile specified for task 340. In other words, the total difference noted above is distributed among the remaining component efforts according to the permissible efforts specified by the planning profile.

For example, assuming that planning profile 445 is specified for task 340, management tool 150 may distribute the total difference of 3 hours among the 4 remaining component efforts such that the values are tapering (7.75, 6.75, 5.75, 4.75) as required by planning profile 445. Display area 460 is accordingly shown updated with the tapering values as per planning profile 445. It may be observed that the remaining component efforts for some of the days are greater than the corresponding planned component efforts.

Similarly, display area 470 of FIG. 4D depicts the manner in which remaining component efforts are computed and displayed upon specification of the actual efforts for multiple days (here June 25 and June 26, as indicated by the shaded regions and drag actions/double headed arrows). It may be appreciated that a recomputed value of remaining component effort may be greater than the standard number of hours that can be allocated to a resource for each day (typically, 8 hours).

According to an aspect of the present disclosure, management tool 150 identifies the remaining component efforts having the number of hours greater than the standard number of hours. For each identified remaining component effort, the number of hours above the standard number is indicated as over-allocated hours for the resource in the corresponding day. Such indication of over-allocation provides an early warning for potential delays or inferior end quality for the task (340).

For example, the over-allocation of hours may be indicated to the user using a different shaded/colored region. Display area 475 shown as a striped line region (along with the numerical value ‘9’) indicates an over-allocation of the resource Dona on June 27. The user/task manager may accordingly be able to identify (and correct) any over-allocations of resources for individual tasks.

Thus, a user is enabled to change the remaining components efforts of an individual task (340) by specifying the actual efforts. It may be appreciated that the component efforts (both planned and remaining) are computed when a user input (for example, by manipulation of graphical elements contained in the display graph) requires a change to at least one component effort.

An aspect of the present disclosure facilitates the user to change the total effort required for performing an individual task using the bar graph of FIGS. 4A-4D as described below with examples.

### 9. Changing Total Effort

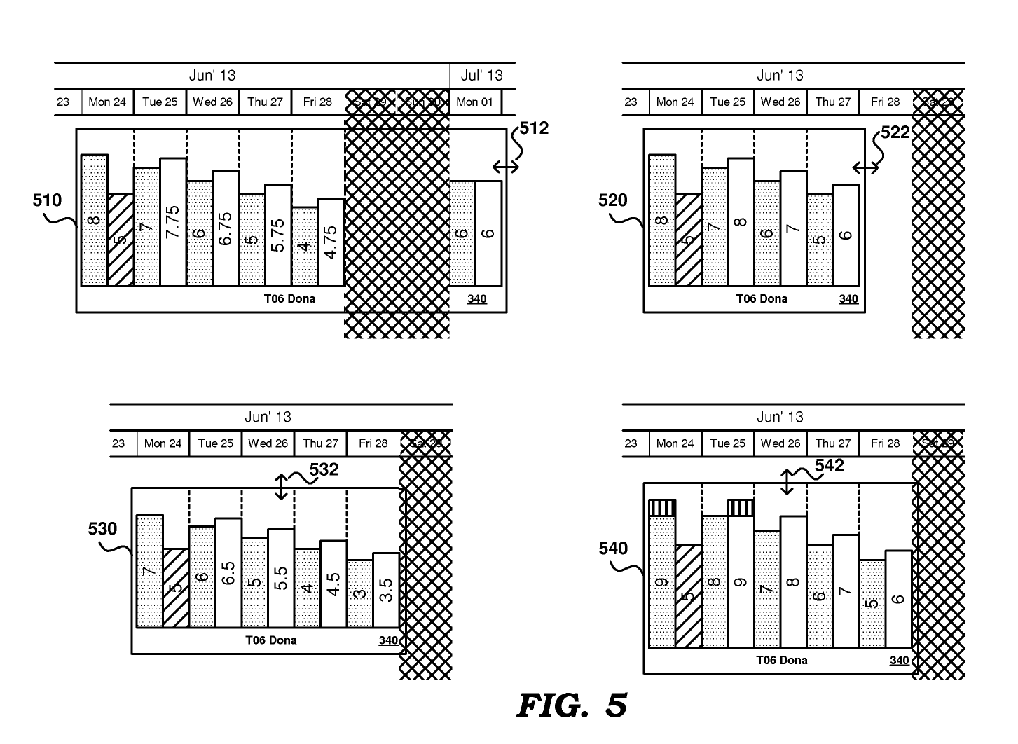

FIG. 5 depicts the manner in which a user/task manager is enabled to change the total effort for an individual task in one embodiment. Each of display area 510, 520, 530 and 540 depicts a corresponding portion of a user interface that is provided on a display unit associated with end user system 160A (similar to display area 300). It may be appreciated that the border of the display area 510, 520, 530 and 540 is a graphical element that may be manipulated by a user/task manager to indicate a change in the total effort.

In one embodiment, a user/task manager uses a pointing device such as a mouse (or a finger in a touch enabled interface) to drag (to a new location) the top or right border shown around the bar graph in a vertical or horizontal direction. The drag action in a horizontal direction of the right border is used to indicate the increase/decrease in the duration (number of days allocated) for the task, while the drag action in a vertical direction using the top border is used to indicate increase/decrease in the number of hours per day for the task. It should be noted that dragging the left border may move the whole task to a different start date, while dragging the bottom border may result in the whole task being repositioned vertically in timeline 320—both actions that are contemplated by the present disclosure. The description is continued assuming that the user is performing the drag actions with respect to the border of the graph shown in display area 460.

Thus, in display area 510, the user is shown performing a drag action (512) along the horizontal direction to indicate the increase of the duration of the task by one working day (finish date is July 1, ignoring Saturday and Sunday). In response, management tool 150, adds (and accordingly displays) a planned and remaining component effort with the value set to the previous average effort (6 hours), thereby making the total effort to be equal to (30+6=) 36 hours. The user may thereafter manually change the height of the planned component effort bar shown under July 1 to a desired value.

In display area 520, the user is shown performing a drag action (522) along the horizontal direction to indicate the decrease of the duration of the task by one working day (finish date is June 27). In response, management tool 150 removes the working day and then re-computes (and displays) the remaining component efforts based on the actual effort and the new total effort (30−4=26 hours) is met. The remaining component efforts are accordingly shown to be 8, 7 and 6 (instead of 7.75, 6.75 and 5.75 as in display area 460). It should be noted that the planned component efforts are not changed when the duration of the task is decreased.

In display area 530, the user is shown performing a drag action (532) along the vertical direction to indicate the decrease of 1 hour per day for the task. In response, management tool 150, decreases the total effort by the total number of hours decreased to determine the new total effort of (30−1×5=) 25 hours. Management tool 150 then computes (and displays) the planned component efforts by decreasing each planned effort by the number of hours decreased (hence the values 7, 6, 5, . . . instead of 8, 7, 6, . . . ) and the remaining component efforts based on the actual efforts and the new total effort.

In display area 540, the user is shown performing a drag action (542) along the vertical direction to indicate the increase of 1 hour per day for the task. In response, management tool 150, increases the total effort by the total number of hours increased to determine the new total effort of (30+1×5=) 35 hours. Management tool 150 then computes (and displays) the planned component efforts by increasing each planned effort by the number of hours increased (hence the values 9, 8, 7, . . . instead of 8, 7, 6, . . . ) and the remaining component efforts based on the actual efforts and the new total effort. It may be observed that the planned component effort for June 24 and the remaining component effort for June 25 both indicate that there is a over-allocation (by an hour) for the resource on those days.

Thus, a user/task manager is enabled to change the total effort for an individual task. It may be appreciated that the features of the present disclosure are provided based on effort parameters maintained by management tool 150. A sample set of effort parameters that may be maintained is described below with examples.

### 10. Maintaining Effort Parameters and Planning Profiles

FIG. 6 illustrates the manner in which effort parameters for an individual task to be performed by a resource is maintained in one embodiment. For illustration, it is assumed that data store 120 is implemented as a database server and accordingly effort parameters are maintained in the form of tables 600 in a database in the database server. However, in alternative embodiments, the effort parameters may be maintained in any other format such as XML (Extensible Markup Language), as will be apparent to one skilled in the relevant arts by reading the disclosure herein.

Table 600 depicts some of the effort parameters maintained in data store 120 corresponding various tasks (T01-T06) shown in timeline 320. Column 621 (“Task Name”) specifies a unique identifier for each task. Column 622 (“Total Effort”) specifies the total effort in number of hours allocated for each task. Columns 623 (“Start Date”) and 624 (“Finish Date”) specifies the corresponding start and finish dates (and together, the duration) for each task. Column 625 (“Resource”) specifies the name of the resource allocated to each task. Column 626 (“Status”) specifies the current status of each task.

Each of rows 641-646 specifies the details of a corresponding task represented in the timeline. In particular, row 646 specifies that the task named T06 requires a total effort of 30 hours, starts from “June 24” and finishes on “June 28” (duration of 5 days), is allocated to resource “Dona”, and the status is “In progress”. Similarly the other rows specify the details of other tasks (T01 through T05) shown in display area 320 of FIG. 3.

Thus, the effort parameters are maintained in the form of table 600 in a database in data store 120. It may be appreciated that by the total effort required for a task and the duration of the task facilitates management tool 150 to compute the day-wise planned/remaining component efforts. In one embodiment, management tool 150 maintains the computed component efforts in the form of a table in data store 120 as described in detail below.

Table 650 depicts the manner in which component efforts are maintained in data store 120. Column 661 (“Task Name”) specifies the unique identifier for each task. Columns 662 (“Date”), 663 (“Planned Effort”) and 664 (“Remaining/Actual Effort”) specifies respectively a date, the corresponding planned effort for the date and the corresponding remaining/actual effort for the date.

Thus, each of rows 671-675 specifies a sequence of component efforts (in number of base intervals/hours) required from a resource (Dona) for an individual task (T06) over the progression of super intervals/days. It may be observed that the progression of days in rows 671-675 corresponds to the days between (and including) the start and finish dates of the task. The planned and remaining efforts shown in table 650 correspond to the efforts computed management tool 150 in response to drag action 462 in display area 460 of FIG. 4D. The planned and remaining efforts in columns 663-664 may be updated in response to various drag actions (indicating change in planned, remaining, and actual efforts) noted above.

As noted above, an aspect of the present disclosure facilitates the user/task manager to create and apply planning profiles to the various component efforts from a resource for a task. In one embodiment, management tool 150 stores the planning profile in the form of a table in data store 120 as described in detail below.

Table 680 depicts the manner in which a planning profile is maintained in data store 120. Column 691 (“Profile Name”) specifies the unique identifier for each planning profile. Columns 692 (“Day”) and 693 (“% wrt average”) specifies respectively a day in the planning profile and the corresponding percentage with respect to average effort to be specified for the day. In other words, positive values in column 693 indicate that the component effort for the corresponding days are greater than the average effort, while negative values in column 693 indicate that the component effort for the corresponding days are less than the average effort. A zero value in column 693 for a day indicates that the component effort for the day is equal to the average effort.

Thus, rows of table 680 together specify a planning profile having the unique identifier P100 that is for a sequence of 5 days (the number of rows) and where the component efforts are gradually rising up (as indicated by the values moving from a negative to positive over the days). It may be appreciated that planning profile P100 corresponds to the planning profile shown in display area 465 of FIGS. 4D and 4E. Thus, the rows of table 680 may be added in response to the user creating the planning profile using the interface of display area 460 in FIG. 4D, and may be accessed (and later used for changing the component efforts) in response to the user/task manager indicating that planning profile P100 is to be applied to task 340 in the user interface of display area 470 in FIG. 4E.

It should be appreciated that the features described above can be implemented in various embodiments as a desired combination of one or more of hardware, executable modules, and firmware. The description is continued with respect to an embodiment in which various features are operative when executable modules are executed.

### 11. Digital Processing System

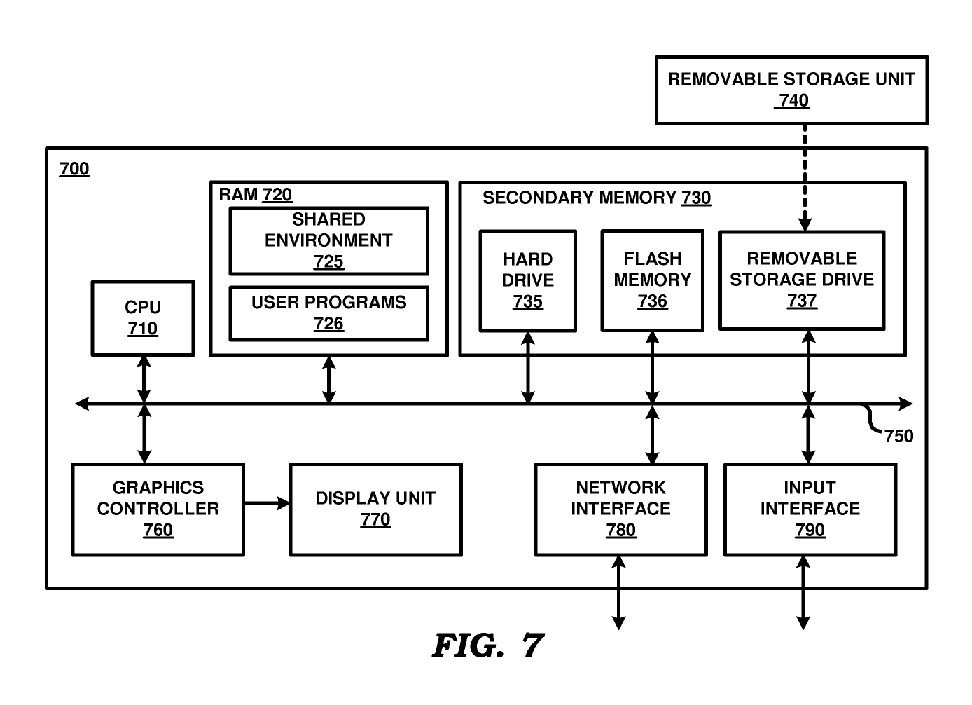

FIG. 7 is a block diagram illustrating the details of digital processing system 700 in which various aspects of the present disclosure are operative by execution of appropriate executable modules. Digital processing system 700 may correspond to any system (such as server system 130) executing management tool 150.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting operating environment 725 and/or other user programs 726 (such as the instances of task management software, etc.). In addition to operating environment 725, RAM 720 may contain other software programs such as device drivers, virtual machines, etc., which provide a (common) run time environment for execution of other/user programs.

Graphics controller 760 generates display signals (e.g., in RGB format) to display unit 770 based on data/instructions received from CPU 710. Display unit 770 contains a display screen to display the images defined by the display signals. Each of the displays shown in FIGS. 3, 4A-4D and 5 corresponds to an image screen displayed at corresponding time duration on the display screen. Input interface 790 may correspond to a keyboard and a pointing device (e.g., touch-pad, mouse) and may be used to provide inputs (such as those provided by the users using the interfaces of FIGS. 3, 4A-4D and 5 as described above). Network interface 780 provides connectivity to a network (e.g., using Internet Protocol), and may be used to communicate with other systems connected to the network (such as end user systems 160A-160X, server system 130, etc.).

Secondary memory 730 may contain hard drive 735, flash memory 736, and removable storage drive 737. Secondary memory 730 may store the data (for example, portions of the data shown in FIG. 6) and software instructions (for implementing the steps of FIG. 2), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Secondary memory 730 may contain hard drive 735, flash memory 736, and removable storage drive 737. Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 12. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of facilitating planning of effort for individual tasks, said method comprising:
maintaining effort parameters for a task to be performed by a resource, wherein said effort parameters together specify a corresponding initial component effort of a sequence of initial component efforts for said resource in each of a progression of super intervals in relation to performance of said task by said resource, each initial component effort being specified in the form of a corresponding number of base intervals;
sending for display a graph containing a first plurality of graphical elements, each of said first plurality of graphical elements representing a corresponding one of said sequence of component efforts over respective one of said progression of super intervals;
receiving an input indicating a change of an effort parameter for said task;
computing a sequence of changed component efforts for said progression of super intervals in response to receiving of said change, wherein each changed component effort is associated with a corresponding super interval of said progression of super intervals; and
sending for updating said graph, said sequence of changed component efforts against said progression of super intervals for said task.

2. The method of claim 1, wherein each base interval is an hour and each super interval is a day.

3. The method of claim 1, wherein said effort parameters together also specify a total effort planned for performance of said task by said resource, wherein said total effort is equal to the sum of said sequence of initial component efforts,
wherein said computing computes said sequence of changed component efforts such that the sum of said sequence of changed component efforts also equals said total effort.

4. The method of claim 3, wherein each of said first plurality of graphical elements has a dimension representing a corresponding component effort for a respective super interval,
wherein said input represents a manipulation of said dimension of a first graphical element of said first plurality of graphical elements such that said manipulation indicates a new component effort corresponding to a first super interval represented by said first graphical element,
wherein said computing computes the changed component effort for said first super interval to equal said new component effort in computing the changed component efforts for the remaining ones of said progression of super intervals while ensuring that the sum of said sequence of changed component efforts also equals said total effort.

5. The method of claim 3, wherein said input indicates a planning profile to be applied to said task, said planning profile specifying a relative distribution pattern of the component efforts over said progression of super intervals,
wherein said computing computes said sequence of changed component efforts consistent with said distribution pattern.

6. The method of claim 5, wherein said distribution pattern is specified relative to an average effort per super interval, wherein the average effort is computed as said total effort divided by the number of super intervals in said progression of super intervals.

7. The method of claim 6, wherein said distribution pattern indicates that the component effort for a first set of super intervals is to be greater than said average effort and the component effort for a second set of super intervals is to be less than said average effort, wherein said first set of super intervals and said second set of super intervals are contained in said progression of super intervals,
based on said distribution pattern, said computing computes the changed component effort for each of said first set of intervals to be greater than said average effort and the changed component effort for each of said second set of intervals to be less than said average effort.

8. The method of claim 6, said method further comprising:
receiving an indication that a new planning profile is to be created with respect to a second task, said second task having a second sequence of component efforts; and
creating a new planning profile based on said second sequence of changed component efforts, in response to said receiving of said indication,
wherein said input indicates that said new planning profile is to be used as said planning profile to be applied to said task,
wherein said second sequence of component efforts define said relative distribution pattern such that said computing computes said sequence of changed component efforts for said task to have the same relative distribution pattern as said second sequence of component efforts.

9. The method of claim 3, wherein said sequence of initial component efforts represent planned efforts for said task,
wherein said effort parameters together also specify a corresponding remaining component effort of a sequence of remaining component efforts for a resource in each of said progression of super intervals in relation to performance of said task by said resource, each remaining component effort being specified in the form of a corresponding number of base intervals,
wherein said sending further sends for display as part of said graph, a second plurality of graphical elements, each of said second plurality of graphical elements representing a corresponding one of a sequence of remaining component efforts over the respective one of said progression of super intervals.

10. The method of claim 9, wherein each of said second plurality of graphical elements has a dimension representing a corresponding remaining component effort for a respective super interval, wherein said input represents a manipulation of said dimension of a second graphical element of said second plurality of graphical elements such that said manipulation indicates said change for a first remaining component effort corresponding to a first super interval,
said method further comprising:
marking said first remaining component effort as an actual effort put in by said resource in the performance of said task during said first super interval; and
determining that said sequence of changed component efforts correspond to a first set of remaining component efforts, wherein said first set of remaining component efforts are the remaining component efforts which have associated super intervals subsequent to said first super interval in said progression of super intervals,
wherein said computing computes said first set of remaining component efforts such that the sum of said first set of remaining component efforts is equal to said total effort less said actual effort.

11. The method of claim 10, further comprising:
identifying a subset of said first set of remaining component efforts having the number of base intervals greater than a standard number of base intervals expected to be put in by said resource in each super interval; and
indicating on said user interface, for each of said subset of first set of remaining component efforts, the number of base intervals above said standard number as over-allocated base intervals for said resource in the corresponding super interval.

12. The method of claim 3, wherein said sending further sends for display as part of said graph, a third plurality of graphical elements representing said total effort,
wherein said input represents a manipulation of a third graphical element of said third plurality of graphical elements such that said manipulation indicates a new total effort for said task by said resource,
wherein said computing computes said sequence of changed component efforts such that the sum of said sequence of changed component efforts equals said new total effort.

13. The method of claim 12, wherein said manipulation is one of extending or reducing said progression of super intervals by one or more super intervals,
wherein said extending indicates that said new total effort is equal to said total effort plus the average effort multiplied by the number of super intervals in said one or more super intervals,
wherein said reducing indicates that said new total effort is equal to said total effort minus the sum of the initial component efforts in said one or more super intervals.

14. The method of claim 12, wherein said manipulation is one of increasing or decreasing the number of base intervals in each super interval to a change number of base intervals,
wherein said manipulates indicates that said new total effort is equal to the number of super intervals in said progression of super intervals multiplied by said changed number of base intervals.

15. The method of claim 1, wherein said sending further sends for display a plurality of tasks including said task for display along a timeline, each of said plurality of tasks having a start time and an end time along said timeline, said method further comprising:
receiving an indication that said task has been selected from said plurality of tasks,
wherein said sending for display said graph is performed in response to said indication.

16. A non-transitory machine readable medium storing one or more sequences of instructions for enabling a system to facilitate planning of effort for individual tasks, wherein execution of said one or more instructions by one or more processors contained in said system enables said system to perform the actions of:
maintaining effort parameters for a task to be performed by a resource, wherein said effort parameters together specify a corresponding initial component effort of a sequence of initial component efforts for said resource in each of a progression of super intervals in relation to performance of said task by said resource, each initial component effort being specified in the form of a corresponding number of base intervals;
sending for display a graph containing a first plurality of graphical elements, each of said first plurality of graphical elements representing a corresponding one of said sequence of component efforts over respective one of said progression of super intervals;
receiving an input indicating a change of an effort parameter for said task;
computing a sequence of changed component efforts for said progression of super intervals in response to receiving of said change, wherein each changed component effort is associated with a corresponding super interval of said progression of super intervals; and
sending for updating said graph, said sequence of changed component efforts against said progression of super intervals for said task.

17. The machine readable medium of claim 16, wherein said effort parameters together also specify a total effort planned for performance of said task by said resource, wherein said total effort is equal to the sum of said sequence of initial component efforts,
wherein said computing computes said sequence of changed component efforts such that the sum of said sequence of changed component efforts also equals said total effort.

18. The machine readable medium of claim 17, wherein each of said first plurality of graphical elements has a dimension representing a corresponding component effort for a respective super interval,
wherein said input represents a manipulation of said dimension of a first graphical element of said first plurality of graphical elements such that said manipulation indicates a new component effort corresponding to a first super interval represented by said first graphical element,
wherein said computing computes the changed component effort for said first super interval to equal said new component effort in computing the changed component efforts for the remaining ones of said progression of super intervals while ensuring that the sum of said sequence of changed component efforts also equals said total effort.

19. A digital processing system comprising:
a processor;
a random access memory (RAM);
a machine readable medium to store one or more instructions, which when retrieved into said RAM and executed by said processor causes said digital processing system to facilitate planning of effort for individual tasks, said digital processing system performing the actions of:
maintaining effort parameters for a task to be performed by a resource, wherein said effort parameters together specify a corresponding initial component effort of a sequence of initial component efforts for said resource in each of a progression of super intervals in relation to performance of said task by said resource, each initial component effort being specified in the form of a corresponding number of base intervals;
sending for display a graph containing a first plurality of graphical elements, each of said first plurality of graphical elements representing a corresponding one of said sequence of component efforts over respective one of said progression of super intervals;
receiving an input indicating a change of an effort parameter for said task;
computing a sequence of changed component efforts for said progression of super intervals in response to receiving of said change, wherein each changed component effort is associated with a corresponding super interval of said progression of super intervals; and
sending for updating said graph, said sequence of changed component efforts against said progression of super intervals for said task.

20. The digital processing system of claim 19, wherein said effort parameters together also specify a total effort planned for performance of said task by said resource, wherein said total effort is equal to the sum of said sequence of initial component efforts,
wherein said digital processing system computes said sequence of changed component efforts such that the sum of said sequence of changed component efforts also equals said total effort.
